(19) United States
(12) Patent Application Publication
(10) Pub. No.: US 2023/0078202 A1
(43) Pub. Date: Mar. 16, 2023

(54) Sign Management System

(71) Applicant: Randy Lee Lisciarelli, Scottsdale, AZ (US)

(72) Inventor: Randy Lee Lisciarelli, Scottsdale, AZ (US)

(73) Assignee: Randy Lee Lisciarelli, Scottsdale, AZ (US)

(21) Appl. No.: 17/829,049

(22) Filed: May 31, 2022

Related U.S. Application Data
(63) Continuation of application No. 63/194,344, filed on May 28, 2021.

(51) Int. Cl. G06Q 10/00

(52) U.S. Cl. CPC G06Q 10/20

(57) ABSTRACT

A system and method is disclosed for managing signs. The system will interact with software as a service and cloud network which will enable users remotely manage signs in various coordinates. In accordance with the embodiment, a mapping program is utilized to enable users to identify, select and manage sign coordinates. The system enables users to edit preferred graphics of signs; identify one or more coordinates associated with the potentiality of signs, determine the number of signs in specified coordinates and identify damaged signs to facilitate repairs. Another embodiment of the disclosure utilizes algorithms that enable the performance of operations.

### FIELD OF THE INVENTION

The present invention generally signage, More specifically, it relates to a SaaS application and cloud network that coordinates signage creation, location placement, installation, management, and retrieval.

### BACKGROUND

Signs (also known as yard signs, bandit signs, placards, and road signs etc.) usually consist of small, placards (made of materials such as but not limited to coroplast, foam board and cardboard etc.) supported by wires, or wood, in the ground that can be placed on lawns to express an opinion (including but not limited to support for an election candidate, a proposition or a political position etc.) by a property owner. Yard signs are popular in political campaigns in the United States and Canada because people want to support their favorite candidate. Politicians have been thriving off of this free advertising to bolster their campaign status and to encourage voters to go out on Election Day. In America, the tradition of signage has existed for centuries and can be traced back to John Quincy Adams in the 1800s. John wanted to get an edge on his opponent in his presidential campaign run and convinced townspeople to put up his signs in their yards and this tactic has been used in every presidential campaign since. Political campaign yard signs typically feature a patriotic theme, promises by politicians, and a slogan. Most yard signage is installed by campaign workers on a ‘drive-by basis.’ in other words, workers simply drive around communities and decide where to place signs as they go rather than plan locations ahead of time. Only a single patent was found related to political signage management. U.S. Pat. No. 7,165,038B1 granted to Ravneet and Simerneet Singh is focused more on sign creation rather than sign installation locations, mapping, and management.

### SUMMARY OF THE INVENTION

The device herein disclosed and described provides a solution to the shortcomings in the prior art through the disclosure of a system for managing signs. An object of the invention is to allow users to create yard sign graphics. For example, a campaign manager can login to the web-based SaaS and select from a wide array of graphic templates to display their messages or slogans. The program includes an artistic pallet that allows users to edit and arrange campaign logos and candidate images.

Another object of the invention is to allow users to calculate the total number of signs to be created based upon their available budget and select exact locations where signage is to be installed. The SaaS incorporates existing mapping frames like Google Map's application programming interface (API) and users place pins where signs are needed to maximize viewing. Google Maps in particular is extremely useful as it has ‘street view’ that allows a user to observe the exact location that will afford the most views in three dimensions and in some instances can suggest physical locations as part of the process.

Another object of the invention is to provide a means to allow users to query voters on mailing lists and ask them to participate in a yard sign effort. For example, a user can upload an email list text file and have the SaaS contact interested residents. These residents can then login to the invention SaaS and opt-in for a sign in their yard and record a set of instructions such as “leave a sign at my doorstep and I will install it,” or “I would like a sign in my yard but I need you to install it for me as I am unavailable.”

Another object of the invention is to provide a means to allow users to generate a ‘sign installation summary’ for campaign workers. For example, after a user enters sign locations they can apply descriptions and the aforementioned resident instructions at each location and the SaaS will automatically send a ‘sign location strategy’ document to the workers that they can print off and bring with them when erecting signage. Once workers install signs at a location they record this status on the SaaS using their cell phones. Workers can also report in on the status of any damaged or missing signs that may need replacing or picking up.

Another object of the invention is to provide a means to allow users to segregate campaign signage and gain the status of placed signage for various campaigns. For example, a campaign manager can login to the SaaS and check whether or not signs have been installed for their party's sheriff, district attorney and mayor at a glance using their smartphone. They can also check to see that signs at various locations have been taken down and retrieved and send reminders to complete removal after a campaign is over.

It is briefly noted that upon reading this disclosure, those skilled in the art will recognize various means for carrying out these intended features of the invention. As such it is to be understood that other methods, applications, and systems adapted to the task ma be configured to carry out these features and are therefore considered to be within the scope and intent of the present invention, and are anticipated. With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other

embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention. As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or nay not be present. By “consisting of” is meant including, and limited to, whatever follows the phrase “consisting of”. Thus, the phrase “consisting of” indicates that the listed elements are required or mandatory, and that no other elements may be present.

B “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may, not be present depending upon whether or not they affect the activity or action of the listed elements. The objects features, and advantages of the present invention, as well as the advantages thereof over existing prior art, which will become apparent from the description to follow, are accomplished by the improvements described in this specification and hereinafter described in the following detailed description which fully discloses the invention, but should not be considered as placing limitations thereon.

### BRIEF DESCRIPTION OF THE FIGURES

The accompanying drawings, which are incorporated herein and form a part of the specification, illustrate some, but not the only or exclusive, examples of embodiments and/or features.

FIG. 1 shows a perspective view of yard signs installed in a community.

FIG. 2 shows a perspective view of the invention app being operated.

FIG. 3 shows a representative view of the invention process.

Other aspects of the present invention shall be more readily understood when considered in conjunction with the accompanying drawings, and the following detailed description, neither of which should be considered limiting.

### DETAILED DESCRIPTION OF FIGURES

In this description, the directional prepositions of up, upwardly, down, downwardly, front, back, top, upper, bottom, lower, left, right and other such terms refer to the device as it is oriented and appears in the drawings and are used for convenience only; they are not intended to be limiting or to imply that the device has to be used or positioned in any particular orientation. Conventional components of the invention are elements that are well-known in the prior art and will not be discussed in detail for this disclosure.

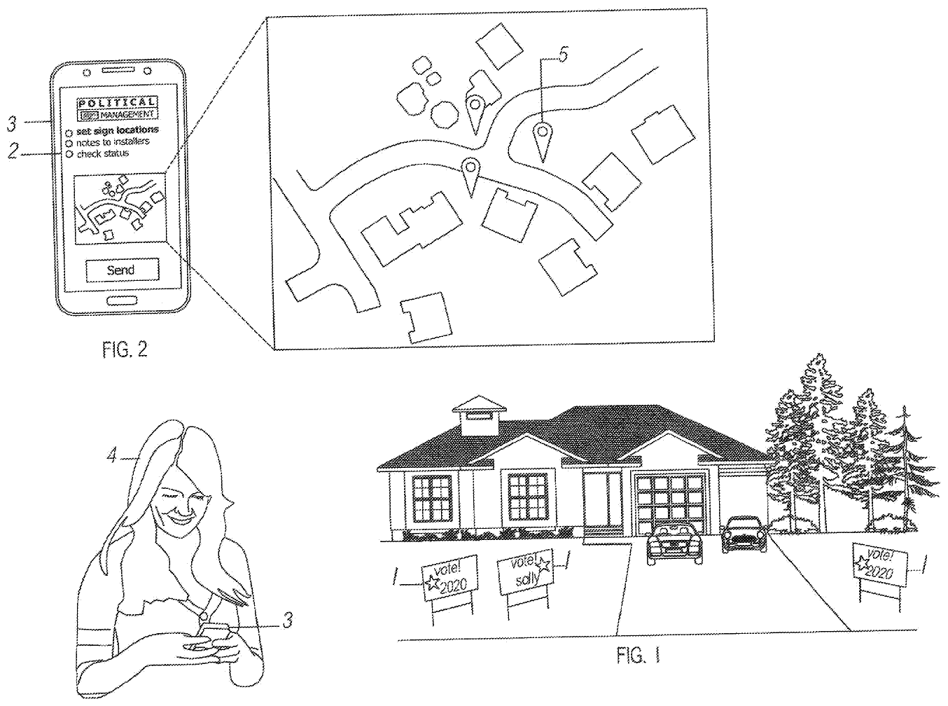

FIG. 1 and FIG. 2 showing the invention being used by user 4 to manage yard signs 1 using SaaS application (app) 2 on a smartphone 3. Said invention SaaS app 3 being written from code that may include, hut not be limited to: Java, (C⁺⁺™, Visual Basic™, Llnux™, Basic™ and the like. The SaaS is also compatible with a plurality of operating systems such as, but not limited to: Windows™, Apple™, and Android™, and compatible with a multitude of hardware platforms such as, but not limited to: personal desktops, laptops, tablets. The SaaS app 2 also having an interactive, inline frame mapping capability with location platforms such as but not limited to Google Maps and the like allowing users to select and mark individual sign locations and broadcasting said locations to other users.

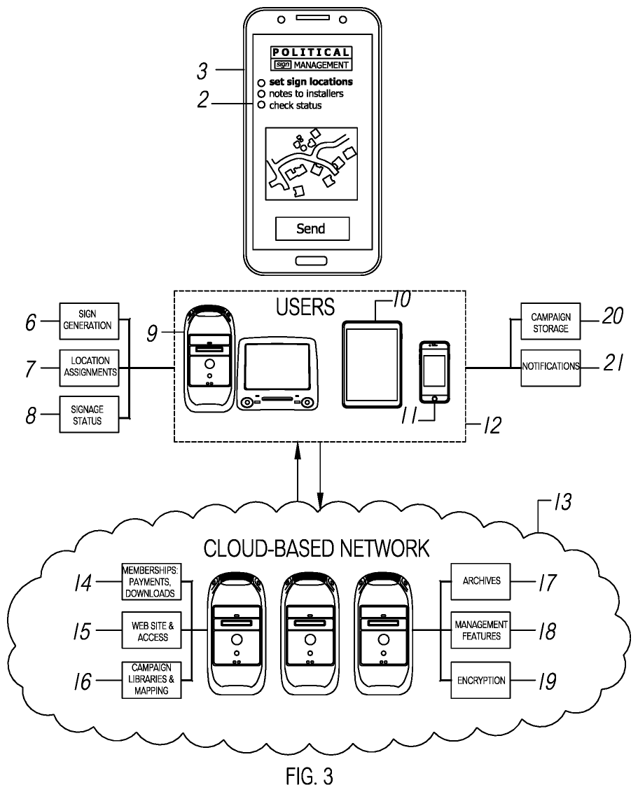

FIG. 3 showing a representative view of the invention process wherein users having access to functions that include but are not limited to: sign generation 6 (selecting from pre-made sign templates and graphics, uploading images and editing slogans etc.); location assignments for signs 7 (interacting with inline frame maps such as Google Maps etc. and placing ‘pins’ for sign positions on said maps); observing sign status 8 (sign not installed, sign installed, sign removed etc.); campaign storage 20 (directories and file storage); and notifications 21 (via SMS, text, email etc.). The users having the ability to operate the SaaS on a multitude of computing devices 12 such as but not limited to desktop computers 9, tablets 10, and smartphones 11. The invention residing on cloud-based network 13 and having algorithms performing operations such as but not limited to: membership accounts (demographics and contact info etc.), payments (links to Paypal, Venmo etc.) and downloads (mobile apps etc.) 14; website portal and access privileges 15 (backend etc.); campaign libraries and mapping 16 (said inline frame mapping features etc.); archives 17 Long term campaign and file storage etc.); management features 18 (mailing orders, processing payments, subscriptions, troubleshooting etc.); and encryption (WEPS, DES, AES, and RSA etc.). Other embodiments of the invention having printing, mailing services for users such as but are not limited to custom political postcards, banners and buttons etc.

It is additionally noted and anticipated that although the device is shown in its most simple form, various components and aspects of the device may be differently shaped or slightly modified when forming the invention herein. As such those skilled in the art will appreciate the descriptions and depictions set forth in this disclosure or merely meant to portray examples of preferred modes within the overall scope and intent of the invention and are not to be considered limiting in any manner. While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the scope of the invention.

What is claimed is:

1. A system for managing signs on-premises, the system configured to execute operations causing the system to:
collect data for a collection of computer and mobile systems, the collection of computer and mobile systems comprising a plurality of source systems and a plurality of target systems;
selecting, by a processor, a computing and mobile system from a plurality of computing and mobile systems using software as a service that is written from different codes to be instantiated based upon the user's task to be completed;
selecting, by a server and based on data stored by the processor and software as a service, editable graphics of signs;
determining, by a server and based on data stored by the processor and software as a service, probable locations utilizing location platforms enabling selection and marking of sign locations;
determining, using cloud-based network and algorithms, number of signs in specified coordinates and locations;
enabling, by a software as a service and cloud network, creation of custom signs;
enabling, by a software as a service and cloud network, users to determine preferred location of signs;
receiving, by the server, location data from a first wireless device of the first user;
determining, by the server, one or more coordinates remotely associated with prospective sign locations;
retrieving, by the server in response to the determination, by the server, precise coordinates of sign locations;
providing, based on the software as a service and processor, potential locations, storing in the processor and notifying results based upon the preferred selection and user input;
providing, using cloud-based network and algorithms, the functionalities of the system which enables performance of operations;
retrieving, by the server, information associated with the coordinates from a database, wherein the information comprises various prospective sign locations;
identifying, based on the software as a service and processor, popular locations with high exposure for setting up signs;
selecting, based on the software as a service and processor, popular locations with high exposure for setting up signs;
providing, based on the software as a service and processor, status of signs in various locations;
transmitting, by a processor, information pertaining to location setup, installation and repair of damaged signs;

2. The method of claim 1, wherein the one or more coordinates associated with a sign location are configured to define a perimeter of the location, wherein determining that the sign is located at specified coordinates is based on a determination that the location data is inputted by the user;

3. The method of claim 1, further comprising transmitting to subsequent devices, wireless or otherwise, the location of the sign.

4. The method of claim 1, further comprising transmitting to subsequent devices, wireless or otherwise, the status of signs in various locations.

5. One or more computer-readable non-transitory storage media comprising software that is operable when executed by a server to:
determine, by the server and based on data stored by the processor and software as a service, to a group of users, location of signs;
receive, by the server, location data from a device, wireless or otherwise, of the user;
determine, by the server, one or more coordinates associated with the location of signs;
retrieve, by the server in response to the determination that a sign is located at a certain coordinate, information associated with the status of the sign from a database,
establishment from a database, wherein the information comprises at least a name of the coordinates; and information associated with the coordinates from a database, wherein the information comprises various prospective sign locations;

6. A server comprising:
one or more processors; and
one or more mobile or computer-readable non-transitory storage media coupled to one or more of the processors and comprising instructions operable when executed by one or more of the processors to cause the server to:
determine, by the server and based on data stored by a processor, location and status of signs;
determining, using cloud-based network and algorithms, number of signs in specified coordinates and locations;
retrieving, by the server, information associated with the coordinates from a database, wherein the information comprises various prospective sign locations;
identifying, based on the software as a service and processor, popular locations with high exposure for setting up signs;
selecting, based on the software as a service and processor, popular locations with high exposure for setting up signs;
transmitting, by a processor, information pertaining to location setup, installation and repair of damaged signs;
